(19) United States
(12) Patent Application Publication
(10) Pub. No.: US 2008/0110981 A1
(43) Pub. Date: May 15, 2008

(54) PROJECTED USER INPUT DEVICE FOR A FUEL DISPENSER AND RELATED APPLICATIONS

(75) Inventors: Jonathan DeLine, Oak Ridge, NC (US); Leon B. Smith, Greensboro, NC (US); Jack F. Bartlett, Summerfield, NC (US); Phillip W. Neal, Liberty, NC (US); Roger W. Stout, Greensboro, NC (US); Andrew Hawley, Kernersville, NC (US); Darrell L. Harmon, Reidsville, NC (US); Chris Whitley, Greensboro, NC (US)

Correspondence Address: NELSON MULLINS RILEY & SCARBOROUGH, LLP, 1320 MAIN STREET, 17TH FLOOR, COLUMBIA, SC, 29201, US

(73) Assignee: GILBARCO INC., Greensboro, NC (US)

(21) Appl. No.: 11/558,958

(22) Filed: Nov. 13, 2006

(51) Int. Cl. G06F 7/08

(52) U.S. Cl. 235/381

(57) ABSTRACT

Methods and systems for preventing fraudulent acquisition of private transaction information associated with customer input at a fuel dispenser are disclosed. According to one embodiment, a fuel dispenser includes a hose and nozzle combination that receives fuel to dispense to the customer's vehicle. The fuel dispenser includes a user interface having a display and a virtual keypad that is adapted to receive customer input associated with a transaction at the fuel dispenser. The fuel dispenser also includes a control system coupled to the user interface and adapted to determine when customer input is required for the transaction, activate the virtual keypad to facilitate entry of the customer input, receive the customer input from the virtual keypad, deactivate the virtual keypad after the customer input is received, and process the transaction based upon the received customer input.

### FIELD OF THE INVENTION

The present invention relates to a system and method for using a projected user interface for a fuel dispenser and related applications as a more secure and cost effective data entry device. More particularly, the present invention provides for enclosing a projected input interface at a fuel dispenser to prevent fraud for fuel dispenser transactions.

### BACKGROUND OF THE INVENTION

Retail environments, such as gas stations and convenience stores, use fuel dispensers for completing transactions associated with purchases of goods and services. These fuel dispensers include user interfaces that allow customers to interact with the fuel dispensers.

User interfaces at fuel dispensers typically include a display that provides a customer with information associated with a purchase transaction. This information can include an itemized listing of the products or services purchased and a total amount for the sale. The information presented can also include a prompt to the user for payment information. The prompt for payment information can include a request for account or other information required to complete the purchase transaction.

A customer interacts with the fuel terminal to initiate a transaction and to respond to information prompts using an input device, such as a touch screen, keypad, or pointing device. The input device provides the fuel dispenser with information from the customer that allows the fuel dispenser to process the transaction. This information is typically in the form of payment information, such as account information and personal identification numbers (PINs). Account number readers, such as card readers and interrogators, are used to retrieve some of the processing information, but PINs are usually entered manually by a user to ensure that the user is authorized to use the account information that is presented for payment.

However, fuel dispensers are typically open to view by bystanders. “Shoulder surfing” is a term that identifies a bystander that purposefully attempts to view the information on a display of a fuel dispenser or attempts to view a PIN entered on an input device by a customer of a fuel dispenser. Shoulder surfers can memorize the location of input keys and can easily interpret keystrokes at a fuel dispenser from a short distance without electronic equipment. Shoulder surfing has also become more advanced as perpetrators use binoculars and cameras in an attempt to obtain information about a customer's account without detection from more remote locations. By use of advanced surveillance equipment, shoulder surfers can obtain private information about customers of fuel dispensers virtually without detection. Shoulder surfing subjects customers of fuel dispensers to theft of identifying information associated with payment accounts and PINs.

Additionally, keypads of fuel dispensers wear out over time due to continuous and repeated action of their keys by customers. Conventional keypads are mechanical in nature. With use, the contacts within a keypad may also corrode and lose their conductivity. As such, fuel dispensers are plagued with a costly replacement schedule for user interface keypads.

Accordingly, an approach for prevention of fraud at fuel dispensers is needed. Additionally, reduction in maintenance costs for user interface keypads of fuel dispensers is needed.

### SUMMARY OF THE INVENTION

The present invention helps to prevent fraud at fuel dispensers by providing a virtual keypad, such as a virtual laser keyboard (VLK), at a fuel dispenser for data entry related to transactions. The virtual keypad is only illuminated when customer input is required. The virtual keypad is placed within an enclosure so that only the customer can easily see the virtual keypad when it is illuminated for data entry. In addition, when the customer places a hand within the enclosure to enter information, the hand further blocks a bystander's view of the virtual keypad. Furthermore, because the virtual keypad is only illuminated when input is required, the bystander has less opportunity to memorize locations associated with input regions of the virtual keypad and may consequently have a more difficult time acquiring private information associated with the transaction. The virtual keypad layout can be scrambled when projected for successive transactions to further protect against fraudulent acquisition of private transaction information. Additionally, by use of a virtual keypad, maintenance costs for fuel dispenser user interface keypads can be reduced.

In one embodiment, a virtual keypad is located within an enclosure associated with a user interface of a fuel dispenser. A customer can interact with the interface at the fuel dispenser and can enter input information associated with a transaction at the fuel dispenser by placing a hand within the enclosure when the virtual keypad is illuminated. The hand blocks a view of the virtual keypad for any bystanders in front of the fuel dispenser and the enclosure blocks the view from other angles.

In an alternate embodiment, a virtual keypad is located within a sloped enclosure associated with a user interface of a fuel dispenser, where the enclosure is angled and slopes downward away from the face of the fuel dispenser. The angle and downward slope of the enclosure allows the customer a better view of the virtual keypad within the enclosure and further prohibits a bystander in front of the fuel dispenser from viewing information that is input by the customer.

In another embodiment, a virtual keypad is located within an enclosure associated with a user interface of a POS terminal for use on a counter of a retail environment, such as a convenience store. A customer can interact with a POS interface on the counter and can enter input information associated with a transaction at the counter by placing a hand within the enclosure when the virtual keypad is illuminated. The hand blocks a view of the virtual keypad for any bystanders in front of the counter and the enclosure blocks the view from other angles.

In an alternate embodiment, a virtual keypad is located within an enclosure associated with a user interface at a counter of a retail environment, where the enclosure is angled and slopes downward away from the face of the enclosure. The angle and downward slope of the enclosure allows the customer a better view of the virtual keypad within the enclosure and further prohibits a bystander in front of the counter from viewing information that is input by the customer.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates an exemplary embodiment of a fuel dispenser 10 capable of providing fraud protection by use of a virtual keypad, such as a virtual laser keyboard (VLK);

FIG. 2 illustrates an exemplary front detail of an enclosure having a virtual keypad input interface housed within the enclosure;

FIG. 3 illustrates an exemplary side detail of an enclosure having a virtual keypad input interface housed within the enclosure;

FIG. 4A illustrates an exemplary side detail of an enclosure that is angled and slopes downward away from the face of the enclosure having a virtual keypad input interface housed within the enclosure;

FIG. 4B illustrates an exemplary side detail of an enclosure that is angled and slopes downward away from the face of the enclosure having a virtual keypad input interface housed within an enclosure that is adapted to be placed on a counter within a retail environment;

FIG. 5 illustrates a block diagram of an exemplary virtual keypad module;

FIG. 6 is a flow chart illustrating exemplary steps for illuminating a virtual keypad during periods of input for a user interface during a fueling or service transaction;

FIG. 7 is a flow chart illustrating exemplary steps for illuminating a virtual keypad during periods of input for a user interface during a purchase transaction in a retail environment;

FIG. 8A is an exemplary virtual keypad layout for use with a user interface of a fuel dispenser;

FIG. 8B is an exemplary scrambled virtual keypad layout for providing increased fraud protection for a virtual keypad used with a user interface of a fuel dispenser;

FIG. 9 is a flow chart illustrating exemplary steps for scrambling a virtual keypad for increased fraud protection during successive periods of input for a user interface during a purchase transaction in a retail environment; and

FIG. 10 is a schematic diagram of an exemplary retail service station environment capable of providing fraud protection by use of fuel dispensers including virtual keypads.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention helps to prevent fraud at fuel dispensers by providing a virtual keypad, such as a virtual laser keyboard (VLK), at a fuel dispenser for data entry related to transactions. The virtual keypad is only illuminated when customer input is required. The virtual keypad is placed within an enclosure so that only the customer can easily see the virtual keypad when it is illuminated for data entry. In addition, when the customer places a hand within the enclosure to enter information, the hand further blocks a bystander's view of the virtual keypad. Furthermore, because the virtual keypad is only illuminated when input is required, the bystander has less opportunity to memorize locations associated with input regions of the virtual keypad and may consequently have a more difficult time acquiring private information associated with the transaction. The virtual keypad layout can be scrambled when projected for successive transactions to further protect against fraudulent acquisition of private transaction information. Additionally, by use of a virtual keypad, maintenance costs for fuel dispenser user interface keypads can be reduced.

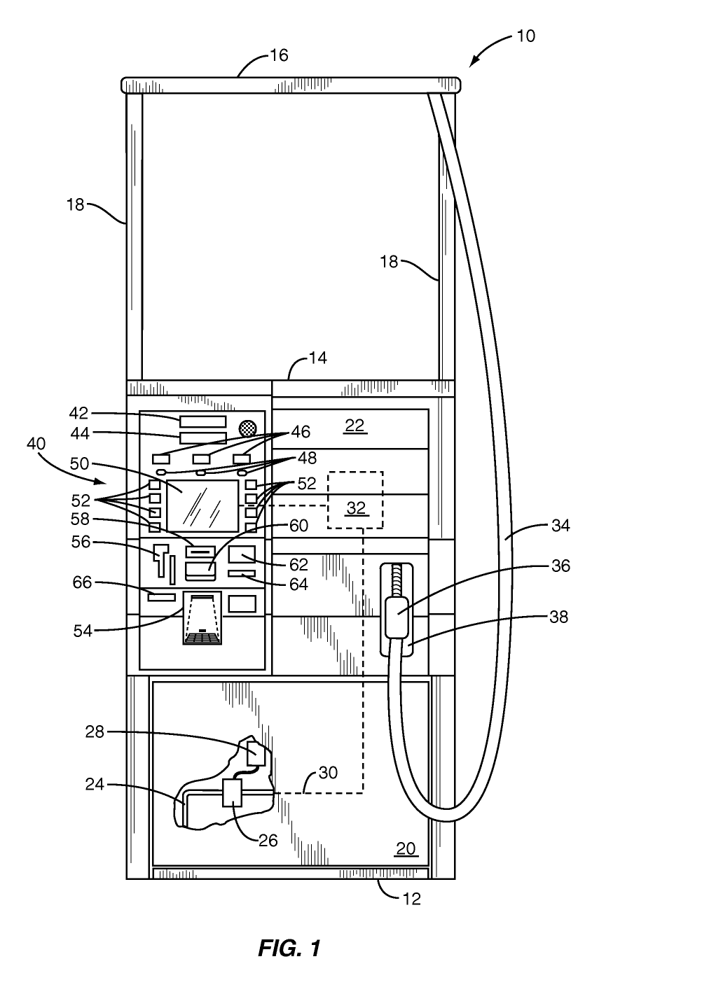

Some basic information about a fuel dispenser 10 is described below before the particular aspects of the present invention are described. FIG. 1 illustrates an exemplary embodiment of the fuel dispenser 10 capable of providing protected data entry using a virtual keypad, such as a virtual laser keyboard (VLK), within an enclosure. The fuel dispenser 10 has a base 12 and a top 14, with a canopy 16 supported by two side panels 18.

The fuel dispenser 10 is subdivided into multiple compartments. A hydraulic area 20 is used to enclose hydraulic components and an electronic area 22 is used to enclose electronic components. A vapor barrier (not shown) may be used to separate the hydraulic area 20 from the electronic area 22.

Several components used to control fuel flow may be housed within the hydraulic area 20. Fuel from underground storage tanks (USTs—not shown) is pumped through a piping network into inlet or fuel dispensing pipes. An inlet pipe 24 provides a piping network from an UST.

When fuel is dispensed, fuel begins to travel through a meter 26, which is responsive to flow rate or volume. A pulser 28 is employed to generate a signal in response to fuel movement through the meter 26. A data line 30 provides a signaling path from the pulser 28 to a control system 32. The data line 30 provides signals to the control system 32 indicative of the flow rate or volume of fuel being dispensed within the meter 26. The control system 32 includes a controller and control circuitry for transaction-level and functional processing within the fuel dispenser 10.

As fuel is dispensed from the fuel dispenser 10, the control system 32 receives signaling from the pulser 28 associated with the meter 26 described above during the dispensing transaction. In response to receipt of signaling from the pulser 28, the control system 32 provides transaction-level functionality within fuel dispenser 10. The control system 32 collects, either directly or indirectly, meter flow measurements associated with the meter 26.

As a dispensing transaction progresses, fuel is then delivered to a hose 34 and through a nozzle 36 into the customer's vehicle (not shown). Fuel dispenser 10 includes a nozzle boot 38, which may be used to hold and retain the nozzle 36 when not in use. The nozzle boot 38 may include a mechanical or electronic switch (not shown) to indicate when the nozzle 36 has been removed for a fuel dispensing request and when the nozzle 36 has been replaced, signifying the end of a fueling transaction. A control line (not shown) provides a signaling path from the electronic switch to the control system 32. The control system 32 uses signaling received via the control line in order to make a determination as to when a transaction has been initiated or completed.

The fuel dispenser 10 also includes a user interface 40 to allow a user/customer to interact with and control a dispenser transaction at fuel dispenser 10. The user interface 40 includes a variety of input and output devices. The user interface 40 includes a transaction price total display 42 that may be used to present the customer with the price to be charged to the customer for fuel. The user interface 40 also includes a transaction gallon total display 44 that may be used to present the customer with the measurement of fuel dispensed in units of gallons or liters as a volume of fuel dispensed from the fuel dispenser 10.

The exemplary fuel dispenser 10 illustrated in FIG. 1 is a multi-product dispenser that is capable of dispensing different grades of fuel. The price-per-unit (PPU) for each grade of fuel is displayed on price displays 46. Octane selection buttons 48 are provided for the customer to select which grade of fuel is to be dispensed before dispensing is initiated.

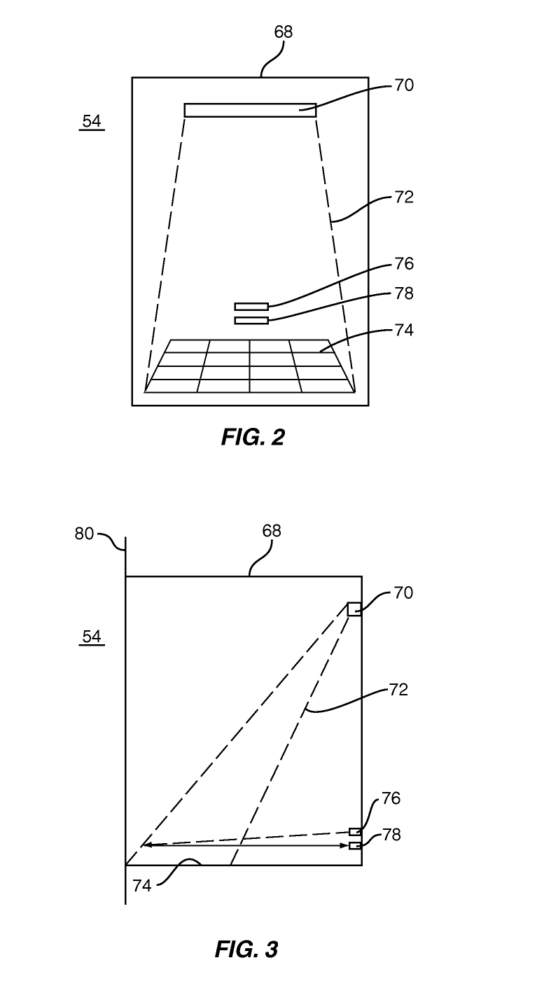

The user interface 40 also includes a display 50 that can be used to provide instructions, prompts, and/or advertising or other information to the customer. Customer selections may be made in response to prompts on the display 50 by use of soft keys 52 or by use of virtual keys associated with a virtual keypad module 54. The soft keys 52 may be designed to align proximate prompts for the customer to indicate his or her desired choice in response to a question or request. As will be described in more detail below in association with FIGS. 2 and 3, the virtual keypad module 54 provides protected data entry during customer payment transactions.

The fuel dispenser 10 may also include a card reader 56 that is adapted to receive a magnetic stripe card, such as a credit or debit card, for payment of fuel dispensed. The fuel dispenser 10 may also include other payment or transactional type devices to receive payment information for transaction processing associated with transactions such as a pre-paid dispenser transaction, including a bill acceptor 58, an optical reader 60, a smart card reader 62, and a biometric reader 64. The fuel dispenser 10 includes a receipt printer 66 so that a receipt with a recording of the dispensing transaction carried out at fuel dispenser 10 may be generated and presented to the customer.

As previously described, the control system 32 may be used to collect metering measurements from pulsers associated with meters within the fuel dispenser 10. The control system 32 also controls the user interface 40 during fuel dispensing transactions, such as providing instructions, prompts, etc. to the customer before, during, and after a fueling transaction. The control system 32 additionally interacts with the virtual keypad module 54 during input portions of a transaction, as will be described in more detail below.

FIG. 2 illustrates an exemplary front detail of the virtual keypad module 54 in accordance with one embodiment of the present invention. The virtual keypad module 54 includes an enclosure 68. A keypad projector 70 emits a beam 72. The beam 72 may be generated by a laser diode. The beam 72 may be passed through a beam refining lens (not shown). The beam 72 is passed through a template (also not shown) of a keypad. A virtual keypad image 74 is thereby projected onto a bottom surface of the enclosure 68.

The virtual keypad image 74 can be projected only when customer input is requested during a transaction at the fuel dispenser 10. The virtual keypad image 74 need not be projected within the enclosure at other times. By not displaying the virtual keypad image 74 at times other than when a customer is actually inputting information, fraud may be prevented by eliminating an opportunity for a bystander to study the virtual keypad input region locations during idle times at the fuel dispenser 10. Without an opportunity to study the virtual keypad input region locations, it should be more difficult for a perpetrator to view a customer's transaction from a distance and interpret the virtual keypad input regions selected by the customer. As such, it should be more difficult for the bystander to interpret input at the virtual keypad module 54.

As will be described in more detail below, the template used to define the input regions associated with the virtual keypad may also be changed, rotated, transposed, or otherwise modified to change the locations of the input regions for the virtual keypad for successive input actions. In this way, bystanders may further be prevented from obtaining private transaction information by being further prevented from memorizing locations for the input regions of the virtual keypad image 74.

Additionally, by placing the virtual keypad module 54 within the enclosure 68, a view of the virtual keypad image 74 will be obstructed for directions other than a direction from which the customer views the virtual keypad image 74. The enclosure 68 may be placed such that the customer looks down onto the virtual keypad image 74 and so that the customer's body can block a view from behind. As well, the enclosure 68 may be narrow enough so that a view of the virtual keypad image 74 is blocked to all persons other than the customer when the customer places a hand into the enclosure 68.

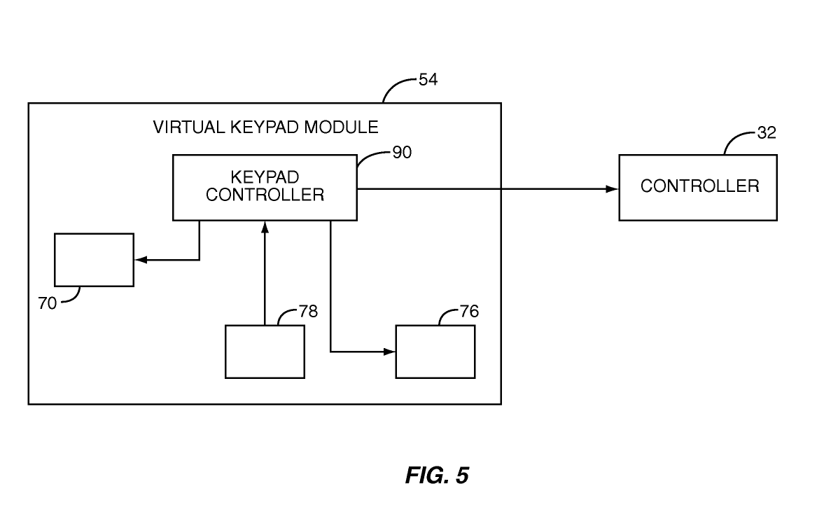

An infrared emitter 76 emits infrared light along a plane that is substantially parallel to the bottom of enclosure 68, as will be described in more detail below. When a customer places a hand within the enclosure 68 of the virtual keypad module 54 and places either a finger, a stylus, or another object onto a virtual input key region that represents an input selection of the virtual keypad image 74, the infrared light emitted from the infrared emitter 76 is reflected and scattered within the enclosure 68. An infrared sensor 78 receives the reflected waves of infrared light. The reflected wave information is processed, as will be described below in association with FIG. 5, and a determination made, based upon the reflected wave information, as to which virtual input key region of the virtual keypad image 74 the customer has selected. The virtual keypad module 54 can provide an input key selection or input key sequence to control system 32 and transaction processing can be completed in a customary fashion.

It should be noted that the orientation of the infrared emitter 76 and the infrared sensor 78 within FIG. 2 is for illustrative purposes only. The infrared emitter 76 and the infrared sensor 78 may be oriented in any fashion that permits the emission of light and sensing of virtual keypad selections by a user.

Applicant hereby incorporates U.S. Pat. No. 7,084,857 to Lieberman et al. (hereinafter “Lieberman”) by reference in its entirety as if fully set forth herein. Lieberman describes a virtual data entry device and method for input of alphanumeric and other data. (See Lieberman, Abstract). The disclosure of Lieberman would be suitable for use in association with the virtual keypad module 54.

FIG. 3 illustrates an exemplary side detail of the virtual keypad module 54. Within this embodiment of the virtual keypad module 54, the enclosure 68 is substantially rectangular. As can be seen from FIG. 3, the virtual keypad image 74 is projected along the beam 72 onto the horizontal bottom surface of the enclosure 68. A face 80 extends beyond the enclosure 68 to facilitate mounting of the virtual keypad module 54 onto the fuel dispenser 10.

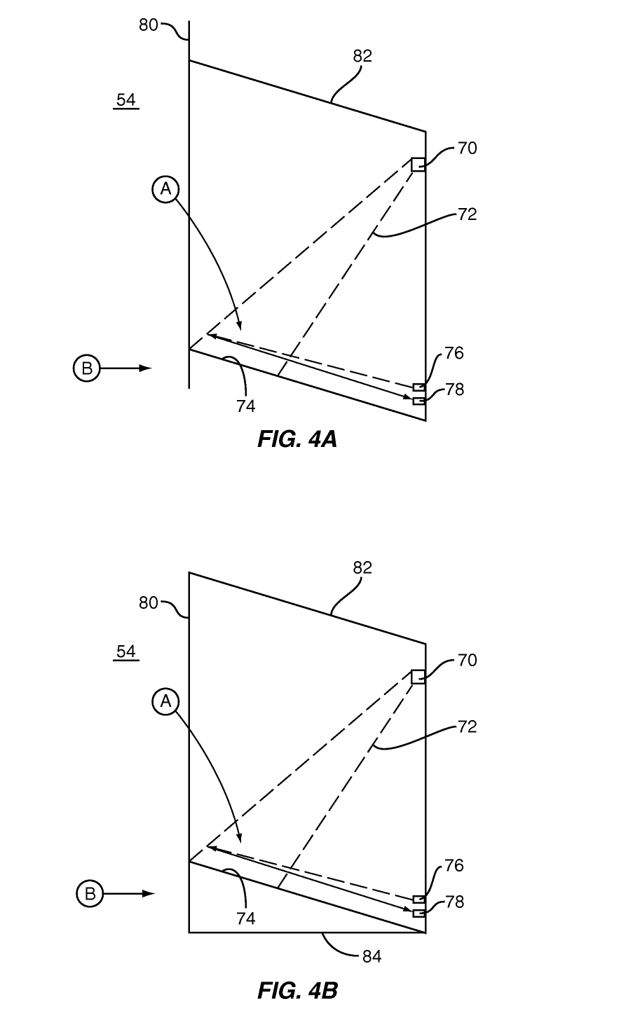

FIG. 4A illustrates an exemplary side detail with an enclosure 82 in place of the enclosure 68 in previous embodiments. The enclosure 82 is angled and slopes downward away from the face 80 of the enclosure 82. As can be seen from FIG. 4A, the projected virtual keypad image 74 is now also angled away from the face 80 of the enclosure 82. When a customer uses the virtual keypad module 54 illustrated in FIG. 4A, the customer will be oriented and view the projected virtual keypad image 74 generally from a location “A.” This orientation will allow the customer to see the projected virtual keypad image 74 during an input transaction, while an onlooker oriented generally at location “B” will not be able to see the virtual keypad image 74. In this way, the enclosure 82 may further enhance privacy at a fuel dispenser, such as the fuel dispenser 10, during input of private information associated with the transaction.

FIG. 4B illustrates an exemplary side detail with the enclosure 82 adapted to be used on a counter in a retail environment. The face 80 is adjusted downward and a bottom 84 is added to the enclosure 82 so that the enclosure 82 can be placed on a counter in a retail environment while still providing the same privacy as described above in association with FIG. 4A.

FIG. 5 illustrates a block diagram of the exemplary virtual keypad module 54. The virtual keypad module 54 may be used within an enclosure, as described above. The virtual keypad module includes the keypad projector 70, the infrared emitter 76, and the infrared sensor 78, as described above. A virtual keypad controller 90 is illustrated within the virtual keypad module 54. The virtual keypad controller 90 interfaces with the keypad projector 70 to generate the virtual keypad image 74, as described above. The virtual keypad controller 90 interfaces with the infrared emitter 76 to generate an infrared light source that is substantially parallel to the surface upon which the virtual keypad image 74 is projected. The virtual keypad controller 90 interfaces with the infrared sensor 78 to interpret reflections of the infrared waves generated by the infrared emitter 76. The virtual keypad controller 90 runs processing algorithms to determine which input segment associated with the virtual keypad image 74 was selected by the user. This information can be further debounced to prevent multiple occurrences of the same input event as with any traditional keypad and can be buffered into an input stream prior to being forwarded to the control system 32 for processing at the transaction level. Further, the virtual keypad controller 90 may provide other security features, such as encryption of information that is entered prior to transmitting it to the control system 32. The control system 32 can process payment transactions to complete the transaction at the fuel dispenser 10.

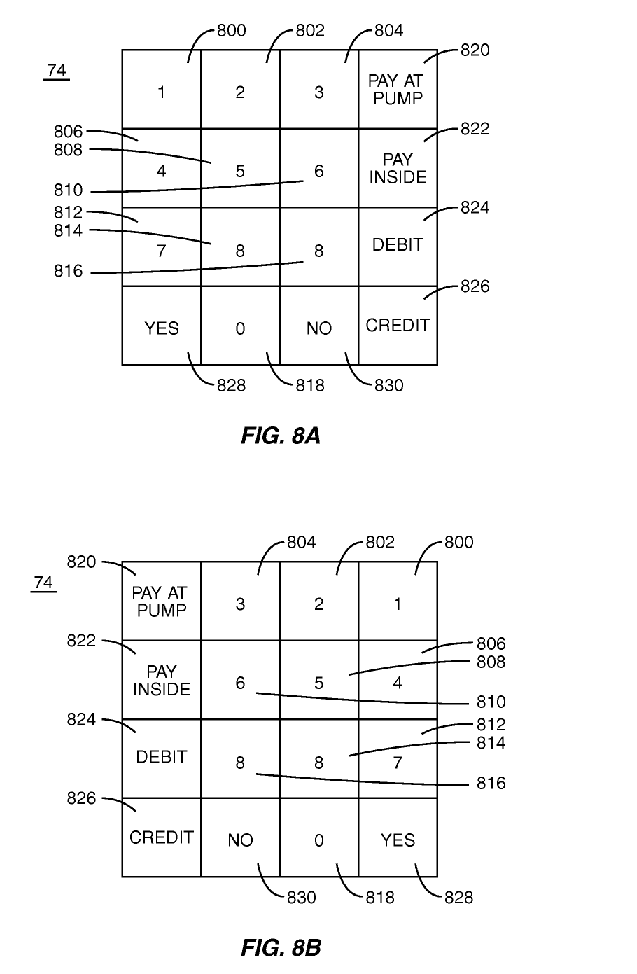

As will be described in detail in association with FIGS. 8A and 8B below, the virtual keypad controller 90 can also scramble the virtual keypad image 74 by, for example, selecting different templates through which to project the virtual keypad image 74 during subsequent input sequences at the virtual keypad module 54. By scrambling the virtual keypad image 74, the virtual keypad controller 90 can rearrange input regions of the virtual keypad module 54 and provide increased protection of private transaction information. By scrambling the input regions, eavesdroppers and shoulder surfers cannot predict the layout of the virtual keypad image 74, and thus, cannot spy on a customer to track hand movements to detect data entry.

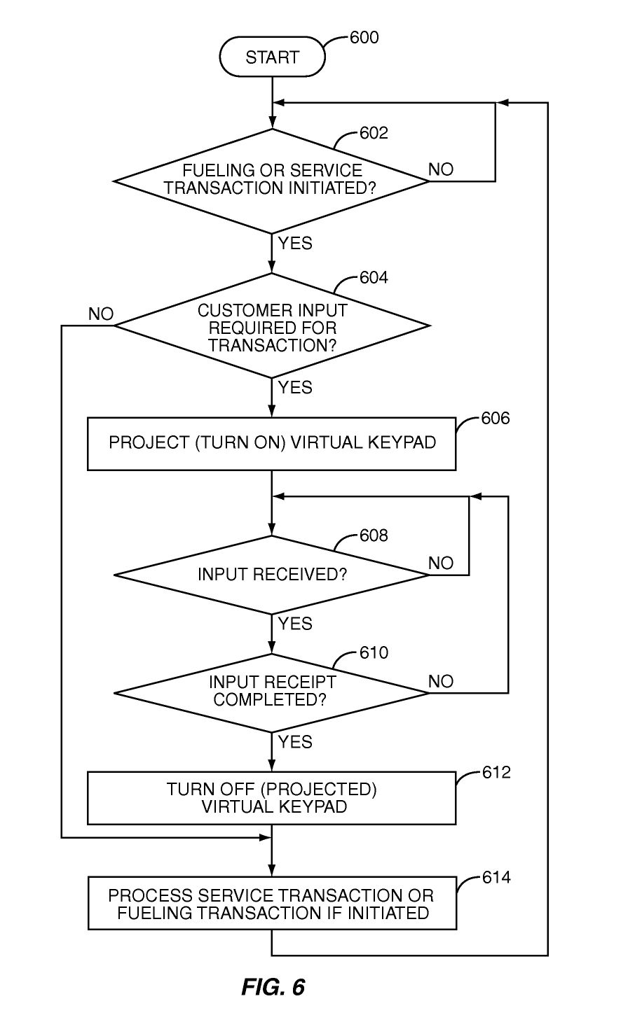

FIG. 6 illustrates exemplary steps for illuminating a virtual keypad, such as the virtual keypad image 74, during periods of input for a user interface during a fueling or service transaction. The process starts (step 600) and waits for a fueling or service transaction to be initiated (decision point 602). When a fueling or service transaction is initiated, the process determines whether customer input is required for the transaction (decision point 604). Actions taken when customer input is not required will be described after the following description of actions taken when customer input is required.

When customer input is required, the process turns on and projects the virtual keypad image 74 (step 606). The process waits for customer input (decision point 608) and upon receipt of customer input makes a determination as to whether the customer input is complete (decision point 610). When the customer input is not complete, the process again waits for the next customer input (step 608) and iteratively receives customer input until a determination is made that the customer input is completed (decision point 610). When the customer input is completed, the process turns off the projected virtual keypad image 74 (step 612).

When either the virtual keypad image 74 is turned off (step 612) or when a determination is made that customer input is not required for the transaction (step 604), the fueling or service transaction is processed, if initiated (step 614) and the process returns to wait for a new transaction (decision point 602).

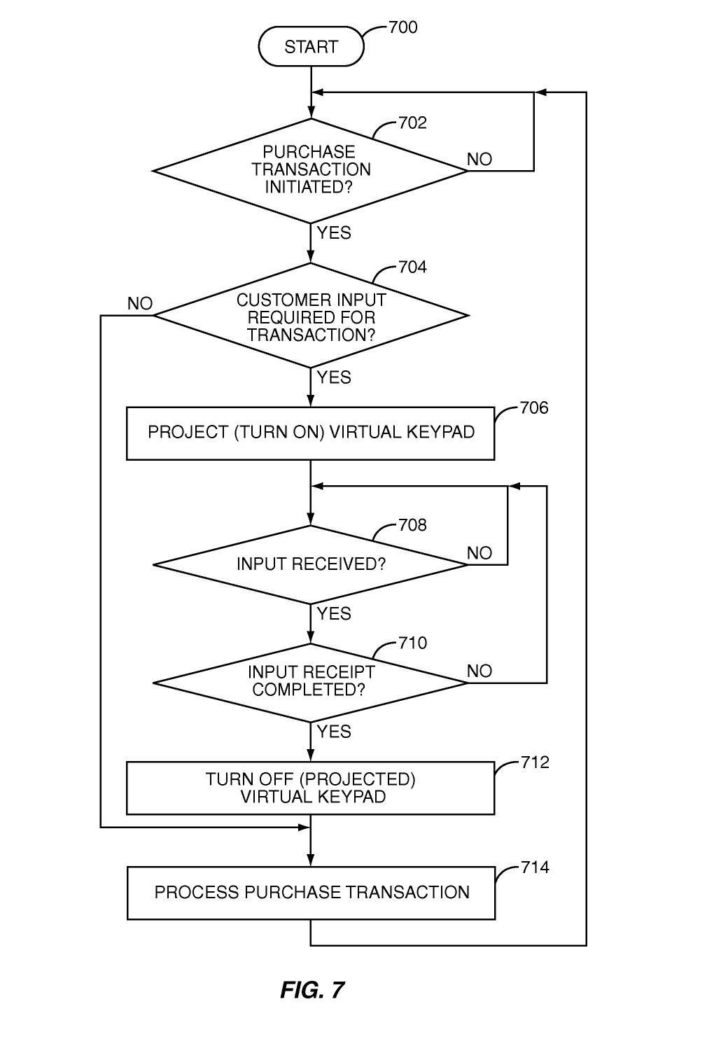

FIG. 7 illustrates exemplary steps for illuminating a virtual keypad, such as the virtual keypad image 74, during periods of input for a user interface during a purchase transaction in a retail environment. The process starts (step 700) and waits for a purchase transaction to be initiated (decision point 702). When a purchase transaction is initiated, the process determines whether customer input is required for the transaction (decision point 704). Actions taken when customer input is not required will be described after the following description of actions taken when customer input is required.

When customer input is required, the process turns on and projects the virtual keypad image 74 (step 706). The process waits for customer input (decision point 708) and upon receipt of customer input makes a determination as to whether the customer input is complete (decision point 710). When the customer input is not complete, the process again waits for the next customer input (step 708) and iteratively receives customer input until a determination is made that the customer input is completed (decision point 710). When the customer input is completed, the process turns off the projected virtual keypad image 74 (step 712).

When either the virtual keypad image 74 is turned off (step 712) or when a determination is made that customer input is not required for the transaction (step 704), the purchase transaction is processed, if initiated (step 714) and the process returns to wait for a new transaction (decision point 702).

By enabling and projecting the virtual keypad image 74 only during times of user input, the present invention limits visibility of the virtual keypad image 74 during the times of non-use. Accordingly, fraudulent acquisition of private customer information may be reduced at a fuel dispenser by preventing extensive study of the keypad layout and virtual key positions by would-be shoulder surfers.

FIG. 8A illustrates an exemplary virtual keypad layout for use within a fuel dispenser, such as the fuel dispenser 10. The exemplary layout represents potential input region locations for virtual input key regions of the virtual keypad image 74. As can be seen from FIG. 8A, the virtual input key regions represent sequential numeric keys. It should be noted, however, that this representation should not be considered limiting because any input key representations needed for a user interface, such as user interface 40, may be represented with a virtual keypad image, such as the virtual keypad image 74.

Virtual input key regions 800, 802, 804, 806, 808, 810, 812, 814, 816, and 818 represent virtual number keys for the numbers one (1) through zero (0), respectively. A virtual input key region 820 represents a virtual input key for a customer to indicate an intent to “pay at the pump” for fuel, products, or services. A virtual input key region 822 represents a virtual input key for a customer to indicate the intent to “pay inside” for fuel, products, or services. In the event the customer chooses to pay at the pump, virtual input key regions 824 and 826 represent virtual input keys for a customer to indicate that the payment presented will be either a debit or a credit payment, respectively. Virtual input key regions 828 and 830 represent virtual input keys for a customer to use to respond to inquiries presented on the display 50 associated with the user interface 40 so that the customer can indicate either “yes” or “no,” respectively, in response to the inquiries.

As described above, the virtual keypad image 74 need only be displayed during portions of a transaction that are associated with user input that is related to the transaction. In this way, onlookers may be prevented from identifying the exact locations of the virtual input key regions when the user interface 40 is not in use.

Other alternatives that may thwart onlooker attempts to identify the virtual input key regions 800-830 that are associated with the virtual keypad image 74, include changing the template that is associated with the projected virtual keypad image 74. This change may be performed for each new transaction or may be performed randomly or periodically after a predetermined or variable number of transactions have occurred at the user interface 40. Further, all of the virtual input key regions 800-830 may be changed or a subset of the regions may be changed.

FIG. 8B illustrates an exemplary scrambled virtual keypad layout for providing increased fraud protection for a virtual keypad used within a fuel dispenser, such as the fuel dispenser 10. As described above, all of the virtual input key regions 800-830 may be scrambled or a subset may be scrambled. FIG. 8B illustrates scrambling of all of the virtual input key regions 800-830. FIG. 8B represents a mirror image of the virtual keypad layout of FIG. 8A.

As can be seen from FIG. 8B, the virtual input key regions 800-830 associated with the virtual keypad image 74 have been changed while still maintaining an orderly user interface. Many other arrangements are possible and are limited only by practicalities of design for the virtual keypad module 54. By changing the virtual keypad representations for the virtual input regions associated with the virtual keypad image 74, onlookers may further be prevented from identifying the exact locations of the virtual input key regions when the user interface 40 is in use.

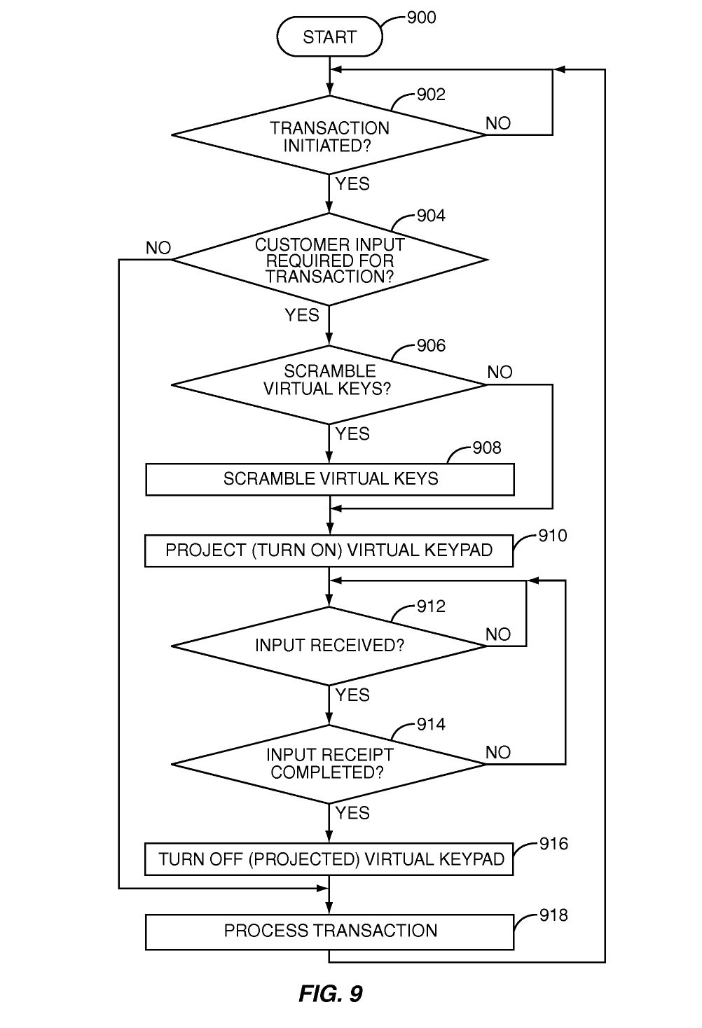

FIG. 9 illustrates exemplary steps for scrambling a virtual keyboard, such as a virtual laser keyboard (VLK), for increased fraud protection during successive periods of input for a user interface during a purchase transaction in a retail environment. The process depicted within FIG. 9 may be used at a fuel dispenser or at any other customer transaction interface such as an automated teller machine (ATM). The process starts (step 900) and waits for a transaction to be initiated (decision point 902).

When a transaction is initiated, the process determines whether customer input is required for the transaction (decision point 904). Actions taken when customer input is not required will be described after the following description of actions taken when customer input is required.

When customer input is required, the process determines whether to scramble or change the virtual key locations for the virtual keypad image 74 (decision point 906). When the process determines that the virtual keypad image 74 is to be scrambled, the process scrambles the virtual keypad image 74 (step 908). Scrambling can include using a separate template for projection of the virtual keypad image 74 or can include optically distorting, reflecting, or otherwise changing the projected virtual keypad image 74. The virtual keypad controller 90 can manipulate a set of templates or lenses associated with the virtual keypad module 54 to facilitate the change or scrambling of the virtual keypad image 74. The virtual keypad controller 90 can use information associated with the projected virtual keypad image 74 to determine coordinates for the virtual input regions for the virtual input keys of the virtual keypad image 74. In this way, the virtual keypad controller 90 can manage all mechanical and algorithmic issues related to scrambling the virtual keypad image 74 and can provide virtual input selection information to the control system 32 when input is received from a customer.

When the process determines that the virtual keypad image 74 is not to be scrambled or when the process completes scrambling of the virtual keypad image 74, the process turns on and projects the virtual keypad image 74 (step 910). The process waits for customer input (decision point 912) and upon receipt of customer input makes a determination as to whether the customer input is complete (decision point 914). When the customer input is not complete, the process again waits for the next customer input (step 912) and iteratively receives customer input until a determination is made that the customer input is completed (decision point 914). When the customer input is completed, the process turns off the projected virtual keypad image 74 (step 916).

When either the virtual keypad image 74 is turned off (step 916) or when a determination is made that customer input is not required for the transaction (step 904), the purchase transaction is processed, if initiated (step 918) and the process returns to wait for a new transaction (decision point 902).

By enabling and projecting the virtual keypad image 74 only during times of user input, the present invention limits visibility of the virtual keypad image 74 during the times of non-use. Accordingly, fraudulent acquisition of private customer information may be reduced at a fuel dispenser by preventing extensive study of the keypad layout and virtual key positions by would-be shoulder surfers.

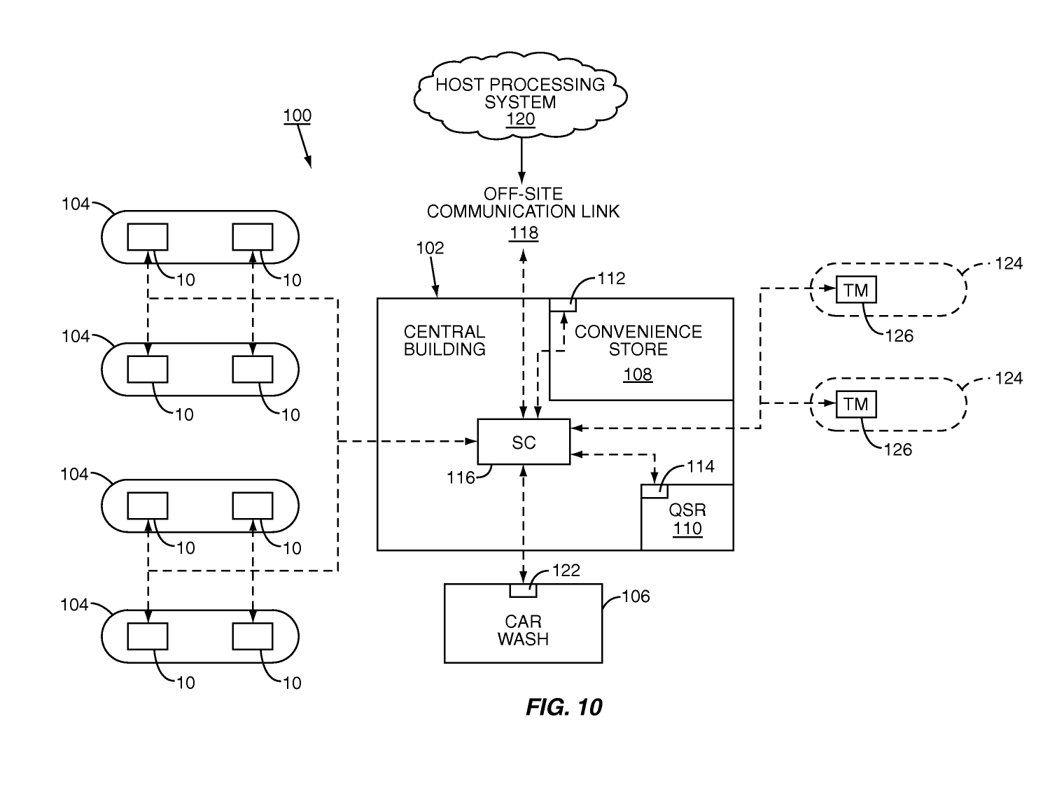

FIG. 10 is a schematic diagram of an exemplary retail service station environment capable of providing fraud protection by use of fuel dispensers including virtual keypads as described above. Additionally, point of sale (POS) terminals within the retail fueling environment may be provided with virtual keypads to provide fraud protection. A conventional exemplary fueling environment 100 is illustrated. The fueling environment 100 includes a central building 102, a plurality of fueling islands 104, and a car wash 106.

The central building 102 need not be centrally located within the fueling environment 100, but rather is the focus of the fueling environment 100, and may house a convenience store 108 and/or a quick serve restaurant (QSR) 110 therein. Both the convenience store 108 and the QSR 110 may include POS 112 and 114, respectively. The POS 112 and 114 may include virtual keypad modules, such as the virtual keypad module 54, to prevent fraudulent acquisition of private transaction information associated with customer input at the POS 112 and 114.

The central building 102 further includes a site controller (SC) 116, which in an exemplary embodiment may be the G-SITE® sold by Gilbarco Inc. of Greensboro, N.C. The SC 116 may control the authorization of fueling transactions and other conventional activities, as is well understood. The SC 116 may be incorporated into a POS, such as the POS 112 and 114, if needed or desired, such that the SC 116 also acts as a POS device. In such a situation, the SC 116 may include a virtual keypad module, such as the virtual keypad module 54, to prevent fraudulent acquisition of private transaction information associated with customer input at the SC 116.

The SC 116 may perform any of the functions described above in association with the control system 32 of the fuel dispensers 10, may act in conjunction with the control system 32 of the fuel dispensers 10, or may replace the control system 32 of the fuel dispenser 10. These functions include controlling fuel dispensing and transaction processing for the fuel dispensers 10, interfacing with the user interface 40 for customer interaction, and interfacing with the virtual keypad module 54 to prevent fraudulent acquisition of private transaction information associated with customer input at the fuel dispenser.

Further, the SC 116 may have an off-site communication link 118 allowing communication with a remote location for credit/debit card authorization via a host processing system 120. The off-site communication link 118 may be routed through the Public Switched Telephone Network (PSTN), the Internet, both, or the like, as needed or desired.

The car wash 106 may have a POS 122 associated therewith that communicates with the SC 116 for inventory and/or sales purposes. The car wash 106 alternatively may be a stand alone unit. U.S. patent application Ser. No. 10/430,689 entitled “Improved Service Station Car Wash,” filed on May 6, 2003, is hereby incorporated by reference as if fully set forth herein as an example of such a car wash that includes a POS terminal.

It should be noted that the car wash 106, the convenience store 108, and the QSR 110 are all optional and need not be present in a given fueling environment.

The plurality of fueling islands 104 may have one or more fuel dispensers 10 positioned thereon. The fuel dispensers 10 are in electronic communication with the SC 116 through a Local Area Network (LAN), pump communication loop, or other communication channel or line, or the like.

The fueling environment 100 also has one or more underground storage tanks 124 adapted to hold fuel therein. As such, the underground storage tanks 124 may be a double-walled tank. Further, each underground storage tank 124 may include a liquid level sensor or other sensor (not shown) positioned therein. The sensors may report to a tank monitor (TM) 126 associated therewith. The TM 126 may communicate with the fuel dispensers 10 (either through the SC 116 or directly, as needed or desired) to determine amounts of fuel dispensed, and compare fuel dispensed to current levels of fuel within the underground storage tanks 124 to determine if the underground storage tanks 124 are leaking. In a typical installation, the TM 126 is also positioned in the central building 102, and may be proximate the SC 116. The TM 126 may communicate with the SC 116 for leak detection reporting, inventory reporting, or the like.

Those skilled in the art will recognize improvements and modifications to the preferred embodiments of the present invention. All such improvements and modifications are considered within the scope of the concepts disclosed herein and the claims that follow.

What is claimed is:

1. A fuel dispenser for dispensing fuel to a customer's vehicle within a retail environment and adapted to prevent fraudulent acquisition of private transaction information associated with customer input at the fuel dispenser, comprising:
a) a hose and nozzle combination that receives the fuel to dispense to the customer's vehicle;
b) a user interface comprising:
i) a display;
ii) a virtual keypad adapted to receive the customer input associated with a transaction at the fuel dispenser; and
c) a control system coupled to the user interface and adapted to:
i) determine when customer input is required for the transaction;
ii) activate the virtual keypad to facilitate entry of the customer input;
iii) receive the customer input from the virtual keypad;
iv) deactivate the virtual keypad after the customer input is received; and
v) process the transaction based upon the received customer input.

2. The fuel dispenser of claim 1 wherein the customer input includes the private transaction information and the control system is adapted to process the transaction using the private transaction information.

3. The fuel dispenser of claim 2 wherein the private transaction information further includes a personal identification number (PIN).

4. The fuel dispenser of claim 1 further comprising a payment reader wherein the control system is adapted to process the transaction by receiving payment account information from the payment reader.

5. The fuel dispenser of claim 4 wherein the payment reader includes at least one of a card reader, an optical reader, and a smart card reader.

6. The fuel dispenser of claim 1 wherein the control system is adapted to process the transaction including a purchase of the fuel from the retail environment.

7. The fuel dispenser of claim 1 wherein the control system is adapted to process the transaction including at least one of a product or service other than the fuel from the retail environment.

8. The fuel dispenser of claim 1 wherein the virtual keypad is adapted to project a virtual image of a keypad on a surface that is substantially flat.

9. The fuel dispenser of claim 8 wherein the virtual keypad is adapted to determine the customer input by projecting light substantially parallel to the surface that is substantially flat and sensing reflections of the projected light to identify input regions of the virtual keypad that are selected by the customer.

10. The fuel dispenser of claim 9 wherein the virtual keypad comprises a virtual laser keypad (VLK) and the projected virtual image of the keypad includes a projected laser image and the projected light includes infrared light.

11. The fuel dispenser of claim 1 wherein the virtual keypad is adapted to scramble input region locations associated with the virtual keypad on subsequent transactions to prevent onlookers from memorizing the input region locations.

12. The fuel dispenser of claim 11 wherein the virtual keypad is adapted to provide an indication to the control system that the input region locations of the virtual keypad have been scrambled.

13. The fuel dispenser of claim 12 wherein the control system is adapted to receive the indication from the virtual keypad that the input region locations of the virtual keypad have been scrambled and to display a message to a customer on the display alerting the customer that the input region locations have been scrambled.

14. The fuel dispenser of claim 1 further comprising an enclosure fixedly attached to the fuel dispenser for housing the virtual keypad, wherein the virtual keypad is adapted to operate within the enclosure and the enclosure is adapted to have a bottom that is substantially flat for projection of the virtual keypad on the bottom and sides that block a view of the virtual keypad from the side by onlookers.

15. The fuel dispenser of claim 14 wherein the enclosure further comprises a bottom that is substantially flat and sloped downward and away from a front of the enclosure to block a view of the virtual keypad from onlookers that are located behind a customer at the fuel dispenser.

16. The fuel dispenser of claim 1 wherein the control system is located within the fuel dispenser.

17. The fuel dispenser of claim 1 wherein the control system is located remotely from the fuel dispenser.

18. A point of sale (POS) device within a retail environment and adapted to prevent fraudulent acquisition of private transaction information associated with customer input at the POS, comprising:
a) a user interface comprising:
i) a display;
ii) a virtual keypad adapted to receive the customer input associated with a transaction at the POS; and
b) a control system coupled to the user interface and adapted to:
i) determine when customer input is required for the transaction;
ii) activate the virtual keypad to facilitate entry of the customer input;
iii) receive the customer input from the virtual keypad;
iv) deactivate the virtual keypad after the customer input is received; and
v) process the transaction based upon the received customer input.

19. The POS device of claim 18 wherein the virtual keypad is enclosed within an enclosure so that it can be placed on a counter within the retail environment.

20. A method of acquiring and preventing fraudulent acquisition of private transaction information from a customer at a fuel dispenser adapted to dispense fuel to a customer's vehicle within a retail environment, comprising the steps of:
a) determining when customer input is required for the transaction at the fuel dispenser;
b) activating a virtual keypad to facilitate entry of the customer input;
c) determining the customer input at the virtual keypad;
d) receiving the customer input from the virtual keypad;
e) deactivating the virtual keypad after the customer input is received; and
f) processing the transaction based upon the received customer input.

21. The method of claim 20 wherein the customer input includes the private transaction information and processing the transaction based upon the received customer input includes processing the transaction based upon the private transaction information.

22. The method of claim 21 wherein the private transaction information further includes a personal identification number (PIN).

23. The method of claim 20 further comprising receiving payment account information from a payment reader and wherein processing the transaction based upon the received customer input includes processing the transaction using the received payment account information.

24. The method of claim 23 wherein the payment reader includes at least one of a card reader, an optical reader, and a smart card reader.

25. The method of claim 20 wherein processing the transaction includes processing a purchase of the fuel from the retail environment.

26. The method of claim 20 wherein processing the transaction includes processing a purchase of at least one of a product or service other than the fuel from the retail environment.

27. The method of claim 20 wherein activating the virtual keypad to facilitate entry of the customer input includes projecting a virtual image of a keypad on a surface that is substantially flat.

28. The method of claim 27 wherein determining the customer input at the virtual keypad includes projecting light substantially parallel to the surface that is substantially flat and sensing reflections of the projected light to identify input regions of the virtual keypad that are selected by a customer.

29. The method of claim 28 wherein the virtual keypad comprises a virtual laser keypad (VLK) and the projected virtual image of the keypad includes a projected laser image and the projected light includes infrared light.

30. The method of claim 20 comprising scrambling input region locations associated with the virtual keypad on subsequent transactions to prevent onlookers from memorizing the input region locations.

31. The method of claim 30 comprising providing an indication that the input region locations of the virtual keypad have been scrambled.

32. The method of claim 31 comprising displaying, in response to the indication that the input region locations of the virtual keypad have been scrambled, a message to a customer on a display alerting the customer that the input region locations have been scrambled.

33. The method of claim 20 wherein activating the virtual keypad further comprises projecting the virtual keypad onto a substantially flat bottom of an enclosure that has sides that block a view of the virtual keypad from the side by onlookers.
